(19) United States
(12) Patent Application Publication
(10) Pub. No.: US 2025/0151146 A1
(43) Pub. Date: May 8, 2025

(54) SIGNALING PREFERENCE ORDER OF LINKS AND MAXIMUM ALLOWED LINKS FOR MULTI-LINK OPERATION

(71) Applicant: Cisco Technology, Inc., San Jose, CA (US)

(72) Inventors: Binita Gupta, San Diego, CA (US); Brian D. Hart, Sunnyvale, CA (US)

(73) Assignee: Cisco Technology, Inc., San Jose, CA (US)

(21) Appl. No.: 18/936,423

(22) Filed: Nov. 4, 2024

Related U.S. Application Data
(60) Provisional application No. 63/596,086, filed on Nov. 3, 2023.

(51) Int. Cl. H04W 76/15; H04W 88/10

(52) U.S. Cl. CPC H04W 76/15; H04W 88/10

(57) ABSTRACT

Signaling preference order of links and maximum allowed links for multi-link operation may be provided. First, an Access Point (AP) Multilink Device (MLD) may receive an indication that a non-AP MLD supports preference ordering for requested links (that are indicated in the Per-STA profile sub-elements). Then the AP MLD may indicate that it supports preference ordering for requested links (that are indicated in the Per-STA profile sub-elements). Next, the AP MLD may receive from the non-AP MLD, a desired preference ordering for the requested link. The AP MLD may then consider the desired preference ordering for requested links.

### RELATED APPLICATION TECHNICAL FIELD

Under provisions of 35 U.S.C. § 119 (e), Applicant claims the benefit of U.S. Provisional Application No. 63/596,086 filed Nov. 3, 2023, which is incorporated herein by reference.

### TECHNICAL FIELD

The present disclosure relates generally to providing signaling preference order of links and maximum allowed links for multi-link operation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing signaling preference order of links and maximum allowed links for multi-link operation;

FIG. 2 is a flow chart of a method for providing signaling preference order of links and maximum allowed links for multi-link operation;

FIG. 3 illustrates a basic ML element;

FIG. 4 illustrates a basic ML element;

FIG. 5 illustrates a basic ML element; and

FIG. 6 is a block diagram of a computing device.

### DETAILED DESCRIPTION

### Overview

Signaling preference order of links and maximum allowed links for multi-link operation may be provided. First, an Access Point (AP) Multilink Device (MLD) may receive an indication that a non-AP MLD supports preference ordering for requested links (that are indicated in the Per-STA profile sub-elements). Then the AP MLD may indicate that it supports preference ordering for requested links (that are indicated in the Per-STA profile sub-elements). Next, the AP MLD may receive from the non-AP MLD, a desired preference ordering for the requested link. The AP MLD may then consider the desired preference ordering for requested links.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11be standard Multilink (ML) operation, a non-AP Multilink Device (MLD) may provide a set of one of more links over which it wants to associate with an AP MLD in the (Re) Association Request. The AP MLD may accept a subset of those links based on criteria such as load balancing over links, channel load conditions, premium link prioritization for certain traffic types/device types, etc. The AP MLD may provide the set of accepted links in the (re) association response frame to the non-AP MLD.

From a non-AP MLD perspective, it may be desirable to indicate its preference order for the links among the set of multiple links it is requesting for (re) association or add link operations. This is so that the AP MLD may take into account the preference order of links provided by the AP MLD when making selection for accepted links (along with other criteria) for (re) association or add links. This is desirable so that the most preferred links may be considered and given priority in the selection. The current IEEE 802.11be standard may not provide a process for a non-AP MLD to indicate its link preferences for (re) association or add link operations.

Additionally, for better management of its resources, an AP MLD that is operating on several links may want to limit the maximum number of setup links a non-AP MLD is allowed to establish. To support this scenario, the AP MLD may advertise a maximum allowed setup links limit.

Accordingly, embodiments of the disclosure may provide signaling to indicate preference order of links among the set of links requested for multi-link (re) association or set of links requested for add link operations, which may enable ML setup of most preferred links by the non-AP MLD. Embodiments may also provide signaling to indicate a maximum number of allowed setup links for a non-AP MLD.

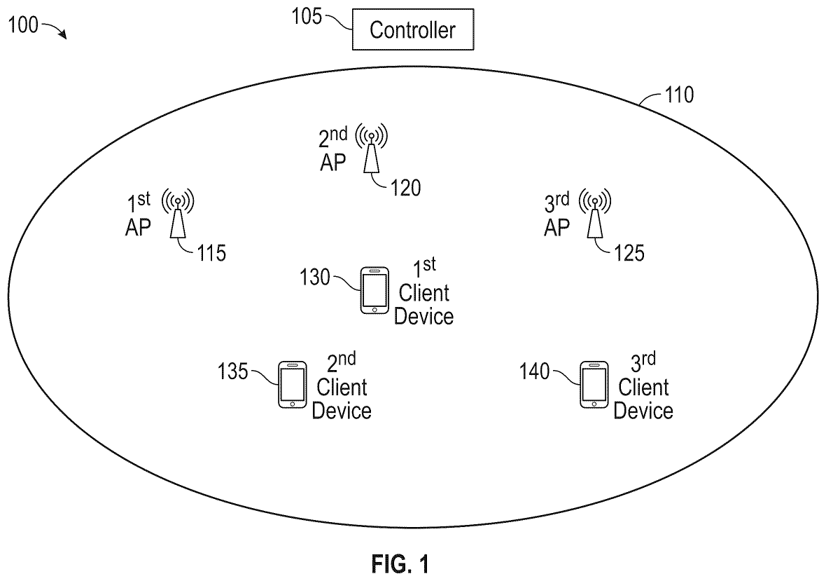

FIG. 1 shows an operating environment 100 for providing signaling preference order of links and maximum allowed links for multi-link operation. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs (e.g., AP Stations (STAs)) may comprise a first AP 115, a second AP 120, a third AP 125. The plurality of APs may provide wireless network access to a plurality of client devices as they move within coverage environment 110. The plurality of client devices (e.g., non-AP STAs) may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (loT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHZ band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide signaling preference order of links and maximum allowed links for multi-link operation.

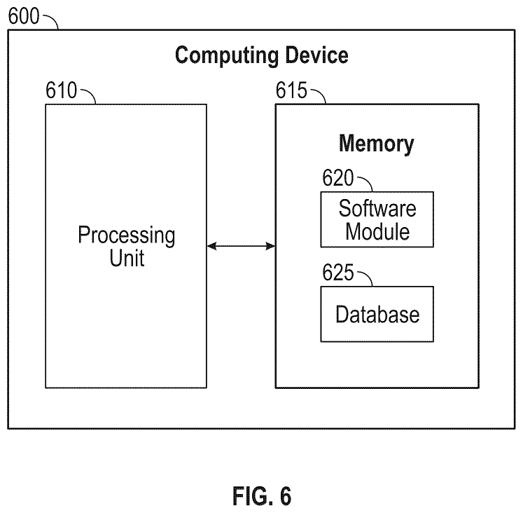

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

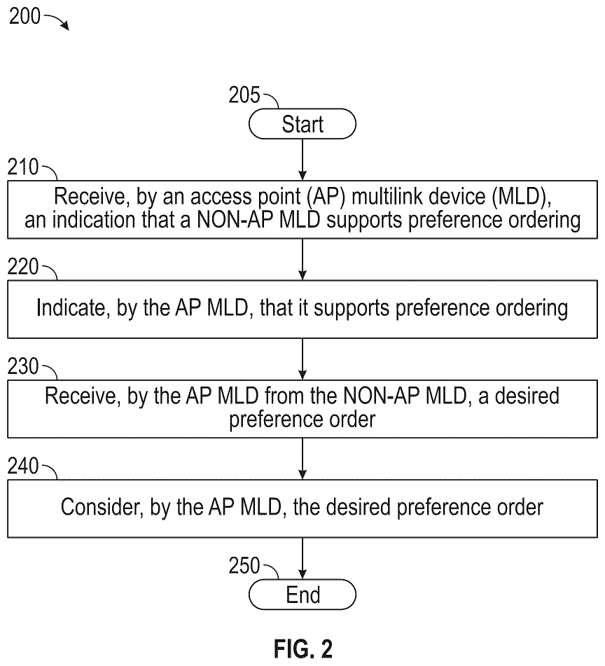

FIG. 2 is a flow chart setting forth the general stages involved in a method 200 consistent with embodiments of the disclosure for providing signaling preference order of links and maximum allowed links for multi-link operation. Method 200 may be implemented using computing device 600 as described in more detail below with respect to FIG. 6. Computing device 600 may be embodied by first AP 115. Ways to implement the stages of method 200 will be described in greater detail below.

One way a non-AP MLD may indicate its preference ordering for requested links is by explicitly ordering the per-STA profile sub-elements for the requested links in the decreasing preference order in a basic ML element of the (Re) Association Request frame. Method 200 may begin at starting block 205 and proceed to stage 210 where first AP 115 may receive an indication that a non-AP MLD (e.g., first client device 130) supports preference ordering. For example, a non-AP MLD may declare its capability for supporting preference ordering for per-STA profiles in a (re) association request frame.

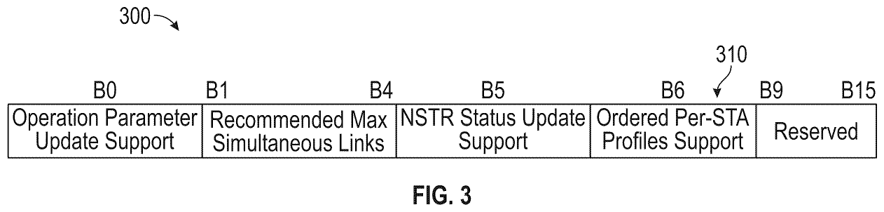

From stage 210, where first AP 115 receives the indication that the non-AP MLD (e.g., first client device 130) supports preference ordering, method 200 may advance to stage 220 where first AP 115 may indicate that it supports preference ordering. For example, an AP MLD may also declare its support for considering received per-STA profiles ordering in selecting accepted setup links. This may be achieved for both stage 210 and stage 220 by indicating a capability bit 310 in the Extended MLD Capabilities and Operations subfield of the Basic ML element 300 as shown in FIG. 3. The capability field may be defined as follows in Table 1. Once both the non-AP MLD and the AP MLD declare their capability for this supporting preference ordering for per-STA profiles for requested links in the (re) association request, the following rules may be followed as illustrated by stages 230 and 240.

TABLE 1

| Subfield | Definition | Encoding |
|---|---|---|
| Ordered Per-STA | Indicates support for a non-AP | Set to 1 if |
| Profiles Support | MLD to order its Per-STA Profiles | dot11OrderedPerSTAProfilesSupportImplemented |
| | in the desired preference order in | is true. |
| | the (Re)Association Request frame | Set to 0 otherwise. |
| | for ML (re)setup and in the Link | |
| | Reconfiguration Request frame for | |
| | add link operations. | |
| | Indicates support for an AP MLD | |
| | to consider received Per-STA | |
| | Profiles ordering in selecting | |
| | accepted setup links. | |

Once first AP 115 indicates that it supports preference ordering in stage 220, method 200 may continue to stage 230 where first AP 115 may receive, from the non-AP MLD (e.g., first client device 130), a desired preference order. For example, a non-AP MLD that has the Ordered Per-STA Profiles Support subfield set to 1 in the Basic ML element and includes multiple Per-STA Profile sub-elements in the (re) association Request frame, orders the per-STA profiles in the desired preference order for requested links when associating with an AP MLD that also has the Ordered Per-STA Profiles Support subfield set to 1 in the Basic ML element it transmits. For example, if a non-AP MLD is requesting to associate on links 1 (2.4 GHZ), link 2 (5 GHz) and link 3 (6 GHZ) and prefers links in the order of (1, 3 and 2), then when sending Association Request on link 1 (2.4 GHZ), it may indicate per-STA profiles in following order in the basic ML element: i) per-STA profile for link 3 (6 GHZ) (first); and ii) per-STA profile for link 2 (5 GHZ) (second).

After first AP 115 receives, from the non-AP MLD (e.g., first client device 130), the desired preference order in stage 230, method 200 may proceed to stage 240 where first AP 115 may consider the desired preference order. For example, the AP MLD that has the Ordered Per-STA Profiles Support subfield set to 1, considers the preference order of links indicated by the ordering of per-STA profiles in the (re) association request frame when selecting accepted links for a non-AP MLD that has the Ordered Per-STA Profiles Support subfield set to 1. Once first AP 115 considers the desired preference order in stage 240, method 200 may then end at stage 250.

### Add Link Operation

In other embodiments, the per-STA profiles ordering to indicate preference ordering for requested links may also be applied to the multiple add link operations requested in the Link Reconfiguration Request frame. The non-AP MLD may explicitly order the per-STA profile sub-elements included in the reconfiguration ML element for multiple add link operations in the decreasing preference order for add links.

The same capability field, the “Ordered Per-STA Profiles Support”, as shown in FIG. 3 for ML setup above may be used to indicate support for preference ordering of per-STA profiles for add links in the Link Reconfiguration Request frame as well. Following rules may be followed for preference ordering of per-STA profiles for link reconfiguration add link operations:
i) A non-AP MLD that has the Ordered Per-STA Profiles Support subfield set to 1 in the Basic ML element and includes multiple add link requests in a Link Reconfiguration Request frame, may order the per-STA profiles for add links in the desired preference order for requested add links, when sending the request to an AP MLD that also has the Ordered Per-STA Profiles Support subfield set to 1 in the Basic ML element.
ii) An AP MLD that has the Ordered Per-STA Profiles Support subfield set to 1, considers the preference order of add links indicated by the ordering of per-STA profiles in the Link Reconfiguration Request frame when selecting accepted add links for a non-AP MLD that has the Ordered Per-STA Profiles Support subfield set to 1 and includes multiple add link requests in a Link Reconfiguration Request frame.

### Alternate Per-STA Profile Ordering

In another embodiment, instead of ordering the per-STA profile sub-elements by decreasing preference order, they may be ordered by increasing preference order. In yet another embodiment, instead of indicating preference by “ordering” the per-STA profile sub-elements, the non-AP MLD may include a new Link Preference field (e.g., 2 or 4 or 8 bits) in the per-STA profile to indicate its relative link preference. The Link Preference field may be included in the STA control field or the STA information field of the per-STA profile sub-element. This embodiment may be helpful for when the link used to transmit the sub-elements is not the most preferred link.

In yet another embodiment, instead of including a Link Preference field for per-STA profiles for ML setup and add link, the non-AP MLD may include a “Non-Preference” or “Undesirability” field for the link.

In still yet another embodiment, the non-AP MLD may order its per-STA profiles for links in the Basic ML element (for ML setup) or the reconfiguration ML element (for add link) without explicitly declaring a capability field for ordering the per-STA profiles. The AP MLD may assume that the non-AP MLDs are ordering their per-STA profiles and takes into consideration the order received when making selection for accepting links for ML setup or add links operation.

### Maximum Allowed Associated Links

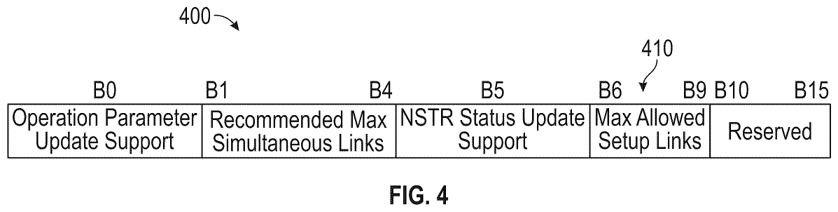

For better management of its resources, an AP MLD that may be operating on several links may wish to limit the maximum number of setup links a non-AP MLD is allowed to establish. To support this scenario, the AP MLD may advertise a Max Allowed Setup Links field 405 in the Basic ML element 400 to indicate the limit to non-AP MLDs as shown in FIG. 4.

The Max Allowed Setup Links field may be defined as follows in Table 2:

TABLE 2

| Subfield | Definition | Encoding |
|---|---|---|
| Max Allowed | Indicates the maximum number of | Reserved when carried in a frame that is |
| Setup Links | setup links which a non-AP MLD is | not a Beacon frame or a broadcast Probe |
| | allowed to establish with the AP | Response frame. |
| | MLD. | Indicates the maximum number of setup |
| | | links which a non-AP MLD is allowed to |
| | | establish with the AP MLD, A value of 0 |
| | | indicates that the AP MLD does not |
| | | advertise any such limit. |

When the Max Allowed Setup Links subfield is set to a non-zero value, the AP MLD may not accept association on number of links greater than the value indicated in the Max Allowed Setup Links subfield.

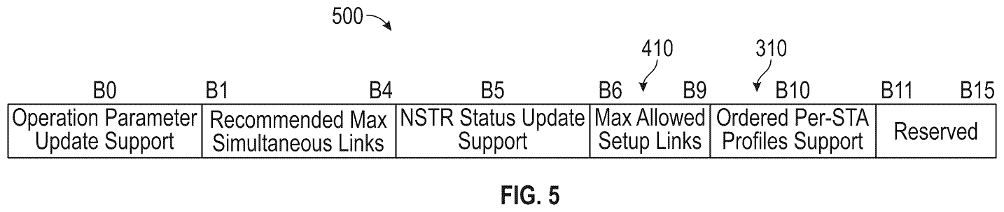

When the Max Allowed Setup Links subfield is set to a non-zero value, the AP MLD may not accept an add link request that may result in a number of setup links becoming greater than the value indicated in the Max Allowed Setup Links subfield. In another embodiment, the non-AP MLD and the AP MLD may support both per-STA profiles ordering capability and the Max Allowed Setup Links subfield in the Basic ML element 500 as shown in FIG. 5.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing signaling preference order of links and maximum allowed links for multi-link operation as described above with respect to FIG. 2. Computing device 600, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by an Access Point (AP) Multilink Device (MLD), a desired preference ordering for requested links; and
considering, by the AP MLD, the desired preference ordering for requested links.

2. The method of claim 1, further comprising:
receiving, by the AP MLD, an indication that a non-AP MLD supports preference ordering for requested links; and
indicating, by the AP MLD, that it supports preference ordering for requested links.

3. The method of claim 2, wherein the indication that the non-AP MLD supports preference ordering for requested links is received in a (re) association request frame in a Basic Multi-link element.

4. The method of claim 3, wherein the indication is made in an ordered per-Station (STA) profiled support subfield.

5. The method of claim 1, wherein the desired preference ordering for requested links is for links requested in a (Re) Association Request frame for multi-link setup.

6. The method of claim 5, further comprises a non-AP MLD ordering Per-STA Profiles sub-elements in a (Re) Association Request frame in a desired preference order in which it wants those links to be considered for multi-link setup.

7. The method of claim 5, further comprises the AP MLD considering the preference ordering for requested links received in a (Re) Association Request frame when selecting accepted links for that multi-link setup.

8. The method of claim 1, wherein the desired preference ordering for requested links is for links requested for add link operations in a Link Reconfiguration Request frame.

9. The method of claim 8, further comprises a non-AP MLD ordering Per-STA Profiles sub-elements in a Link Reconfiguration Request frame in a desired preference order in which it wants those links to be considered for add link operations.

10. The method of claim 8, further comprises the AP MLD considering the preference ordering for requested links received in a Link Reconfiguration Request frame when selecting accepted links for add link operations.

11. The method of claim 1, wherein the desired preference ordering for requested links is in a decreasing preference order.

12. The method of claim 1, wherein the desired preference ordering for requested links is in an increasing preference order.

13. The method of claim 1, wherein the desired preference ordering for requested links further comprises including a link preference field in the per-STA profile sub-element.

14. The method of claim 1, wherein the desired preference ordering for requested links further comprises including a link nonpreference field in the per-STA profile sub-element.

15. The method of claim 1, further comprising advertising, by the AP MLD, a maximum allowable setup links.

16. A system comprising:
a memory storage; and
a processing unit coupled to the memory storage and disposed in an Access Point (AP) Multilink Device (MLD), wherein the processing unit is operative to:
receive a desired preference ordering for requested links; and
consider the desired preference ordering for requested links.

17. The system of claim 16, wherein the processing unit is further operative to:
receive an indication that a non-AP MLD supports preference ordering for requested links; and
indicate that it supports preference ordering for requested links.

18. A non-transitory computer-readable medium that stores a set of instructions which when executed perform a method executed by the set of instructions comprising:
receiving, by an Access Point (AP) Multilink Device (MLD), a desired preference ordering for requested links; and
considering, by the AP MLD, the desired preference ordering for requested links.

19. The non-transitory computer-readable medium of claim 18, further comprising:
receiving, the AP MLD, an indication that a non-AP MLD supports preference ordering for requested links; and
indicating, by the AP MLD, that it supports preference ordering for requested links.

20. The non-transitory computer-readable medium of claim 19, wherein the indication that the non-AP MLD supports preference ordering for requested links is received in a (re) association request frame in a Basic Multi-link element.
